(19) United States
(12) Patent Application Publication
(10) Pub. No.: US 2006/0005457 A1
(43) Pub. Date: Jan. 12, 2006

(54) Fish scent dispensing fishing device

(76) Inventors: Darrell Harris, Oregon City, OR (US); Robert Bedient, Oregon City, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/888,486

(22) Filed: Jul. 9, 2004

(51) Int. Cl. A01K 85/00

(52) U.S. Cl. 43/42.06

(57) ABSTRACT

An embodiment of the invention is a fishing lure or fishing device including a fish scent dispenser to dispense scent derived from a scent source contained therein. A scent source can be added to a cavity defined by the fishing lure or fishing device and a lid portion of the fish scent dispenser when in an open configuration. The scent source can then be secured when the fish scent dispenser is in a closed configuration. The scent contained in or created by the scent source is dispersed through vents in the lid portion when the fishing lure or fishing device is submerged.

### RELATED CASES

This case is related to “Fish Scent Dispenser” filed herewith.

### FIELD

Embodiments of the invention pertain to fishing lure equipment, and more particularly to a scent-dispensing fishing device or scent-dispensing fishing lure.

### BACKGROUND

“I shall stay him no longer than to wish him a rainy evening to read this following discourse; and that if he be an honest angler, the east wind may never blow when he goes a fishing.” Izaak Walton, The Complete Angler, Author's preface.

Recreational or sport fishing has been increasing in popularity. One of the most exciting and popular varieties of sport fishing involves so-called trolling type fishing, in which a number of lines and lures may be pulled behind and to the side of a fishing boat as the boat moves through the open ocean, river, or lake. The variety of lures available to sport fisherman is legendary. Some lures have been designed to attract fish by virtue of arresting and attractive color schemes. Other lures attract fish because, when the lures are drawn behind the boat, the lures undergo an oscillatory pitching or rolling motion. Still other lures are designed to dispense chum or scent meant to attract fish. The practice of chumming involves the dispensation of various fluids or small particulate matter having a particular odor attractive to the fish sought to be caught by the fishermen. If chum is spread in the water by a lure or near a lure, fish are more likely to be attracted and caught.

However, many fish scents commercially available are liquids, powders, or gels that are applied to the exterior of the fishing lure or device that quickly disperse or rub off and must be frequently reapplied. Further, the scents may degrade or otherwise spoil such that the fishing lures and devices must be frequently cleaned to remove any remnants of the scent to avoid repelling fish.

### BRIEF DESCRIPTION OF THE DRAWINGS

The present invention will be understood more fully from the detailed description given below in conjunction with the accompanying illustrations of an embodiment or embodiments of the invention. The illustrations, however, should not be taken to limit the invention, but are for explanation and understanding only.

FIG. 1: illustration of a fishing lure of an embodiment including a scent dispenser.

FIG. 2: illustration of a spinner of an embodiment including a scent dispenser.

FIG. 3: illustration of a dodger of an embodiment including a scent dispenser.

FIG. 4: illustration of a downrigger weight of an embodiment including scent dispenser.

FIG. 5: illustration of a flasher of an embodiment including a scent dispenser.

FIG. 6: illustration of a sliding weight holder of an embodiment including a scent dispenser.

FIG. 7: illustration of a bait holder of an embodiment including a scent dispenser.

FIG. 8: illustration of a diver of an embodiment including a scent dispenser.

FIG. 9: illustration of a diver of another embodiment including a scent dispenser.

FIG. 10: illustration of a fish scent dispenser lid portion including vents.

FIG. 11: illustration of a scent tablet.

It is noted that the drawings of embodiments are merely schematic representations and are not intended to portray specific parameters of the invention. The drawings are intended to depict only typical embodiments of the invention, and therefore should not be considered as limiting the scope of the invention.

### DETAILED DESCRIPTION

Embodiments of fishing lures and devices including fish scent dispensers will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Simply stated, an embodiment of the invention is a fishing lure or fishing device including a fish scent dispenser to dispense scent derived from a scent source contained therein. The fish scent dispenser may be formed by, among other elements, a lid portion including a plurality of vents that is coupled to or part of the fishing lure or fishing device. A scent source can be added to a cavity defined by the fishing lure or fishing device and the lid portion when the lid portion is in an open configuration. The scent source can then be secured when the lid portion is in a closed configuration. The scent contained in or created by the scent source is dispersed through vents in the lid portion when the fishing lure or fishing device including the scent dispenser is submerged.

Further, as used herein, and by way of illustration only, the fish scent source material utilized in an embodiment may be in the form of either solidified or deformable fish attractant material or a liquid applied to a porous material, like a sponge material or hydrophilic foam, that is adapted to absorbedly receive commercially available fish attractant liquid, gel, or paste to be repeatedly impregnated therein.

Further, the description will refer to fishing lures and fishing devices. As used herein, and as understood in the art, fishing lures contain a hook or hooks to catch fish. Fishing devices do not contain hooks, but are used in conjunction with fishing lures to, for example, add attraction or control the depth of the fishing lure.

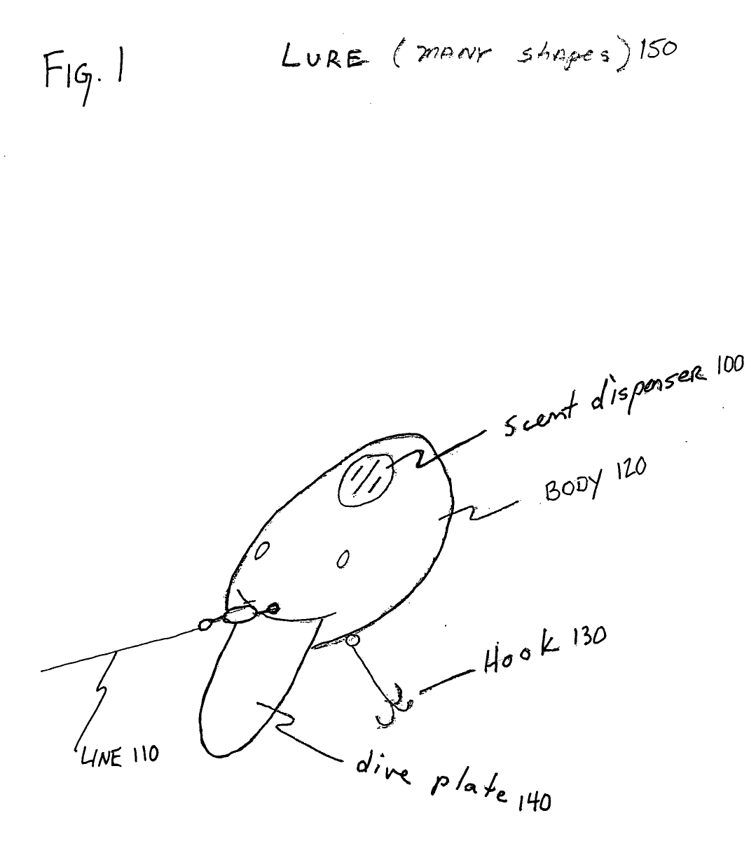

FIG. 1 illustrates a fishing lure 150 of an embodiment including a fish scent dispenser 100. In an embodiment, the fishing lure 150 is a crankbait including, among other elements, a body 120, a hook 130, and a dive plate 140 as is well known in the art. A line 110 may attach the fishing lure 150 to the fisherman's rod and reel. It is to be understood that the crankbait fishing lure 150 may be of any configuration (e.g., color, color combination, size, shape, hook configuration, diving depth, and buoyancy) as is well known in the art.

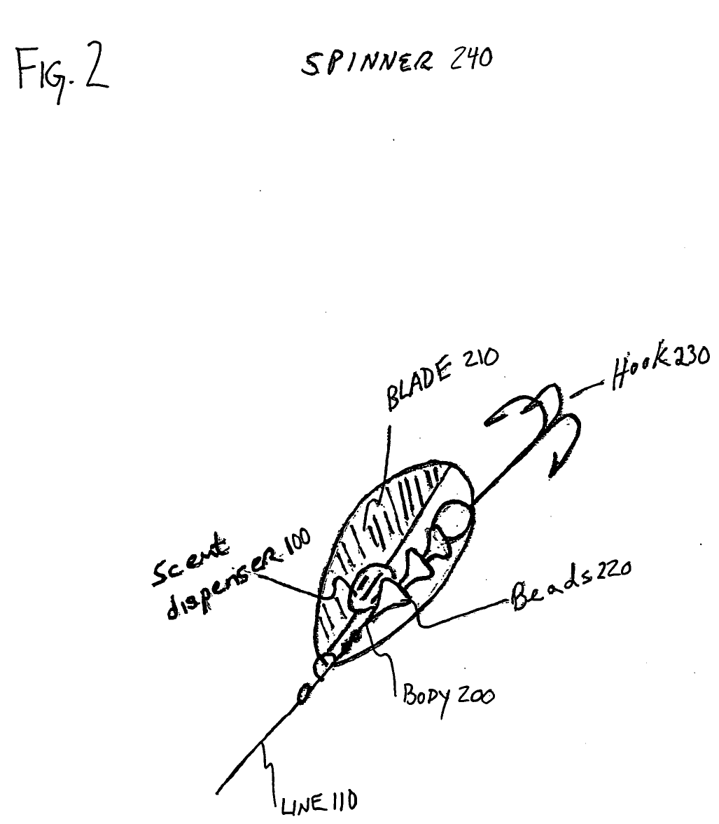

FIG. 2 illustrates a spinner 240 of an embodiment including the fish scent dispenser 100. The spinner includes 240 a body 200, blade 210, beads 220, and hook 230. A line 110 may attach the spinner 240 to the fisherman's rod and reel. It is to be understood that the spinner fishing lure may be of any configuration (e.g., color, color combination, size, shape, hook configuration, and blade configuation) as is well known in the art.

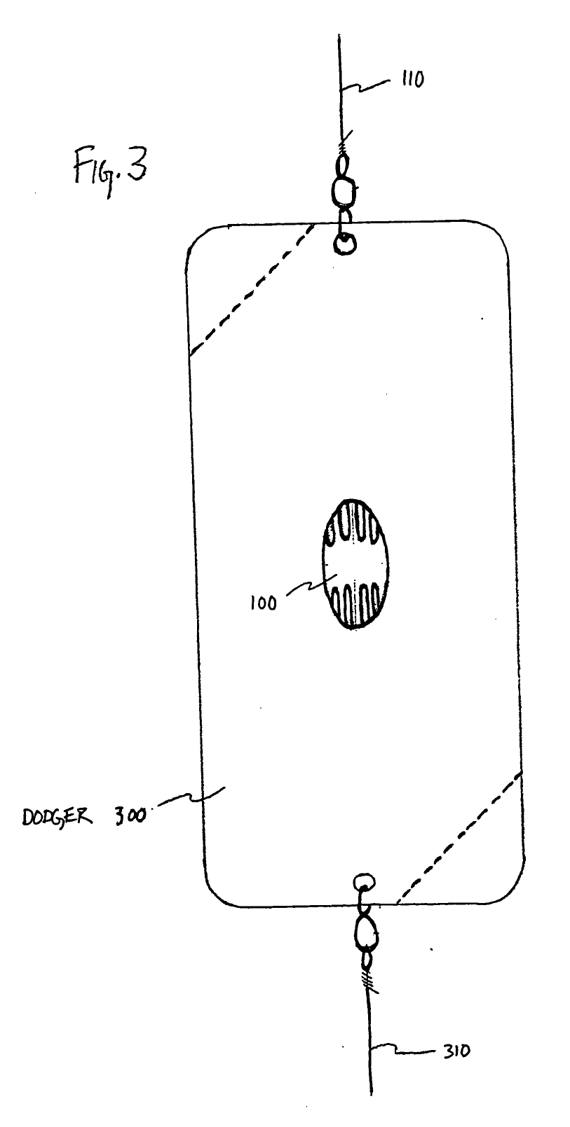

FIG. 3 illustrates a dodger 300 of an embodiment including the fish scent dispenser 100. A dodger 300 is a fishing device that may be inserted in a fisherman's line 110 and line 310 adjacent to the fishing bait or lure containing the hook, and may include swivels to prevent the dodger 300 from twisting the lines 110 and 310. The dodger 300 is designed to spin or otherwise oscillate to attract fish. For example, the dodger 300 may include fish attracting color or color combinations, reflective material (e.g., glitter or metal flakes), glow-in-the-dark material, fluorescent material, and combinations thereof. The dodger 300 may also, by spinning, provide vibrations in the water that attract or otherwise stimulate fish through their lateral line sensitivity.

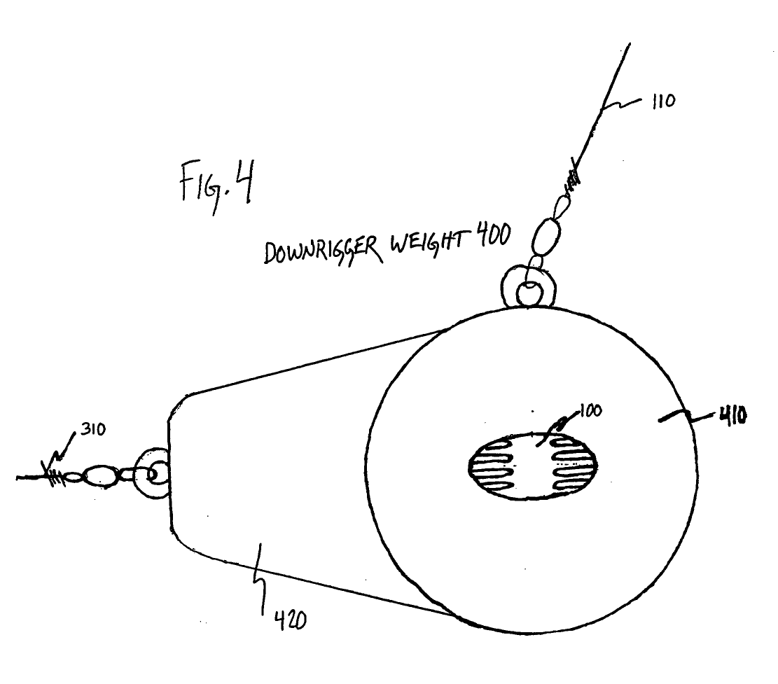

FIG. 4 illustrates a downrigger weight 400 of an embodiment including the fish scent dispenser 100. The downrigger weight 400 may include a weight portion 410 and a fin portion 420. A downrigger weight 400 may attach to a fishing line 110 to control depth of the fishing lure or device that is attached to fishing line 310 as illustrated with respect to dodger 300. The fishing lines 110 and 310 may also attach to swivels.

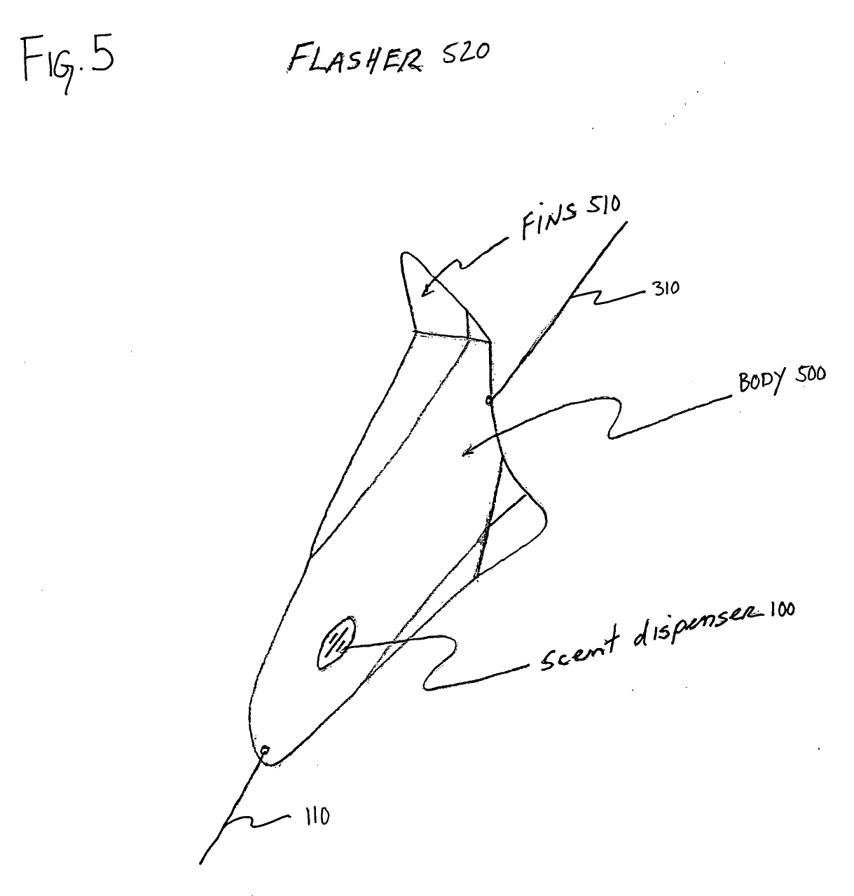

FIG. 5 illustrates a flasher 520 of an embodiment including the fish scent dispenser 100. Like the dodger 300, the flasher 520 is a fishing device that may be inserted in a fisherman's line 110 and line 310 adjacent to the fishing bait or lure containing the hook, and may include swivels to prevent the flasher 520 from twisting the lines 110 and 310. The flasher 520 is designed to spin or otherwise oscillate to attract fish. For example, the flasher 520 may include fish attracting color or color combinations, reflective material (e.g., glitter or metal flakes), glow-in-the-dark material, fluorescent material, and combinations thereof. The flasher 520 may also, by spinning, provide vibrations in the water that attract or otherwise stimulate fish through their lateral line sensitivity.

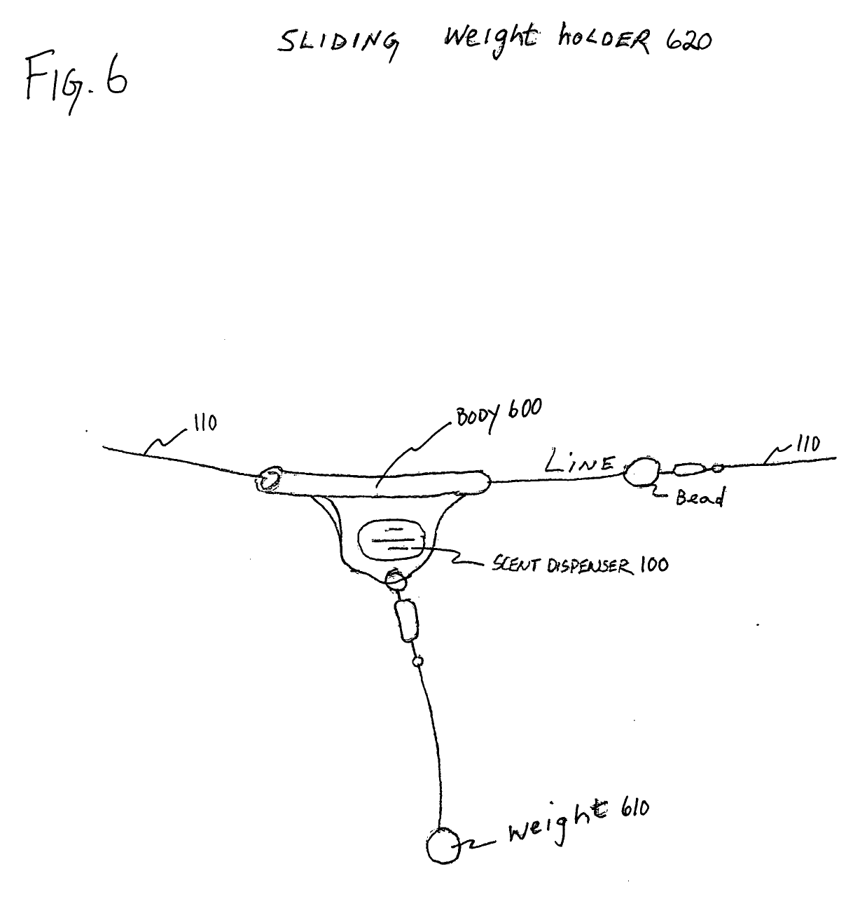

FIG. 6 illustrates a sliding weight holder 620 of an embodiment including the fish scent dispenser 100. The sliding weight holder 620, also called a weight slide, contains a body 600 with, for example, a hollow cylinder through which line 110 runs. The inside diameter of the body 600 hollow cylinder is substantially larger than the outer diameter of the line 110 so that the sliding weight holder 620 indeed slides along the line 110. The inside surface of the hollow cylinder is further non-abrasive so as to not damage line 110 as the sliding weight holder slides along the line 110. The body 600 is further coupled to a weight 610.

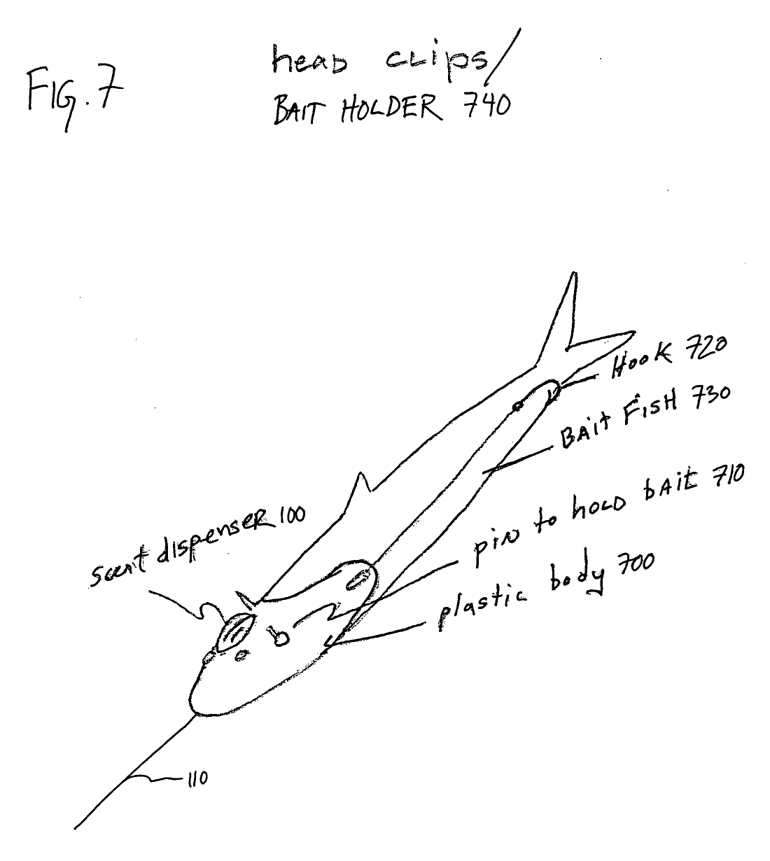

FIG. 7 illustrates a bait holder 740 of an embodiment including the fish scent dispenser 100. The bait holder 740 includes a body 700, a pin 710, and a hook 720. The body 700 is shaped to accept the, for example, head of a bait fish 730 and to secure the bait fish 730 in the body 700 with a pin 710. It should be understood that the bait holder 740 may secure the bait fish 730 by any method known in the art. The bait holder 740 may be attached to fishing line 110.

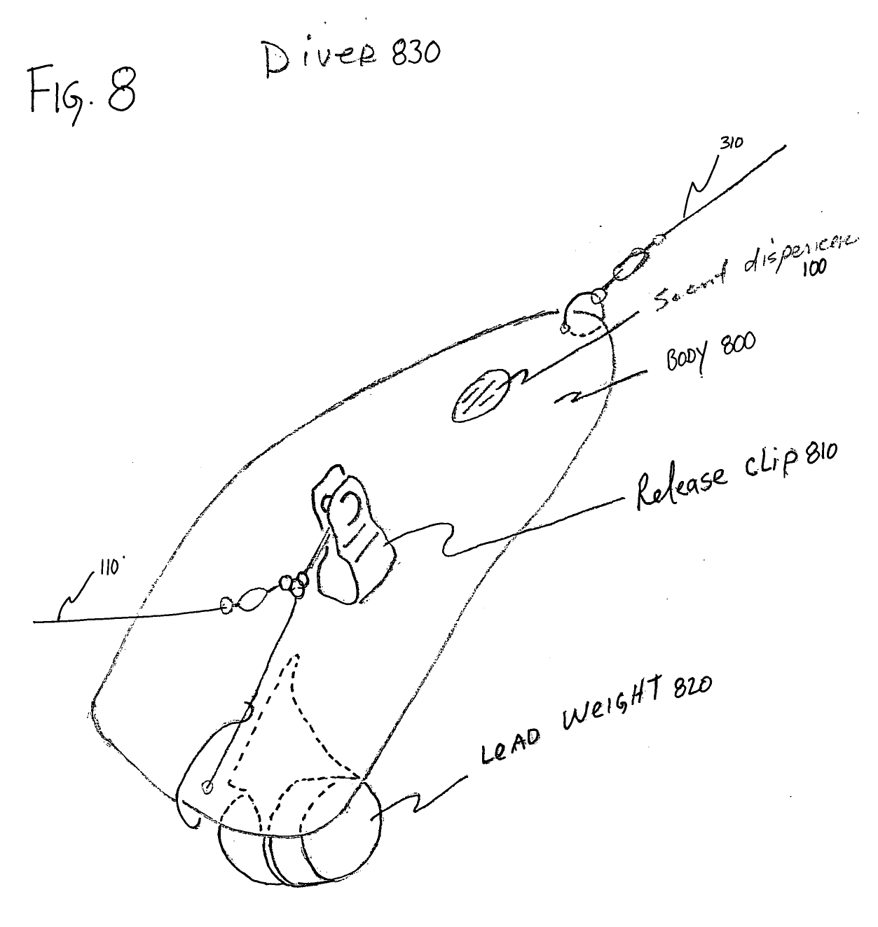

FIG. 8 illustrates a diver 830 of an embodiment including the fish scent dispenser 100. The as with dodger 300 and flasher 520, the diver 830 maybe inserted in a fisherman's line 110 and line 310 adjacent to the fishing bait or lure containing the hook. The combination of the lead weight 820 and the angle of the body 800 create a large dive plate as noted with reference to dive plate 140 of lure 150. When, for example, a fish strikes a bait attached to line 310, the added resistance pulls line 110 from a release clip 810 and substantially aligns the body 800 with line 110 and line 310, reducing the diver's 830 function as a diver and resistance through the water. With such a device, a fisherman can locate a lure or bait attached to line 310 at an appropriate depth, but not have to fight the resistance created by the body 800 when the fisherman has hooked a fish.

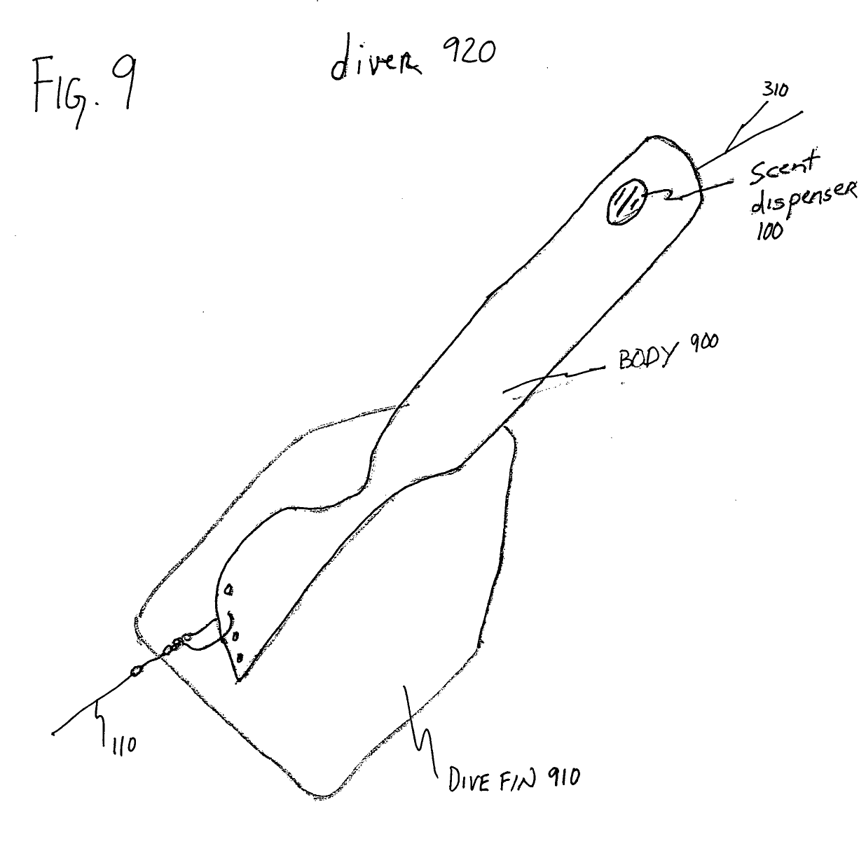

FIG. 9 illustrates diver 920 of an embodiment including the fish scent dispenser 100. As explained with reference to dodger 300, flasher 520, and diver 830, diver 920 may be inserted in a fisherman's line 110 and line 310 adjacent to the fishing bait or lure containing the hook. The location of the line 110 on the body 900 adjusts the angle of dive fin 910 with respect to the water and resulting depth to which the diver 920 dives.

Though illustrated with reference to a variety of specific fishing devices and fishing lures, it is to be understood that the fish scent dispenser 100 can be included in any fishing device or fishing lure from which it would be useful to provide scent. Additional devices include floaters, weights (i.e., sinkers), weight slides, flashers, spinners, divers, side planers, live or natural bait rigs or bait holders, and trolling rudders. Additional fishing lures include crankbaits, an in-line spinners, spinner baits, topwater baits, spoons, jigs, or any other form of artificial fishing bait. It is to be further understood that the fishing lures and fishing devices of embodiments may have any configuration, color, size, or shape as is well known in the art.

Further, thought the fish scent dispenser 100 has been illustrated in FIGS. 1 through 9 as having a particular location or orientation on the respective fishing lures or fishing devices, it is to be understood that the fish scent dispenser 100 can have any location or orientation on the fishing lure or fishing device. There may further be multiple fish scent dispensers 100 included in the fishing lure or fishing device.

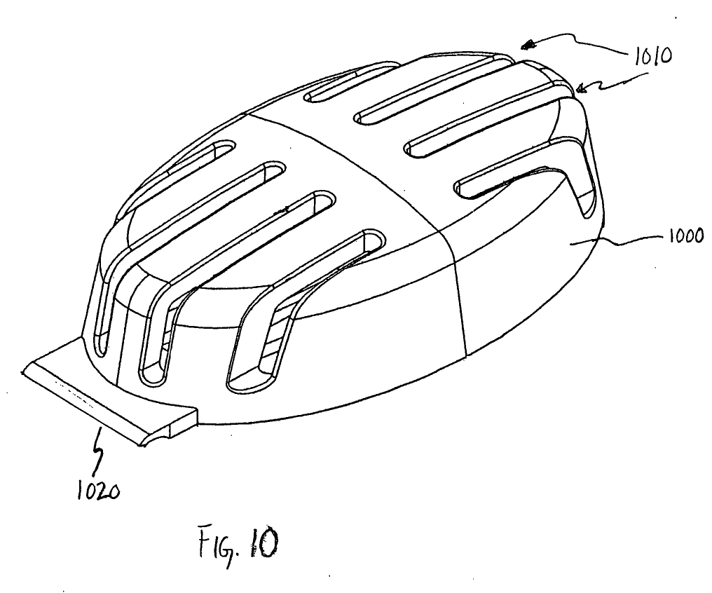

FIG. 10 illustrates an embodiment of a fish scent dispenser 100. The fish scent dispenser includes a lid portion 1000, a plurality of vents 1010, and a hinge 1020. The vents 1010 expose a cavity defined by the lid portion 1000 and the portion of the fishing lure or fishing device adjacent to the lid portion 1000, and any contents therein, to water when the fishing lure or fishing device including the fish scent dispenser 100 is submerged.

The lid portion 1000 of the fish scent dispenser 100 has a closed configuration and an open configuration. In the closed configuration, the lid portion 1000 and the portion of the fishing lure or fishing device adjacent to the lid portion 1000 detachably engage to define a cavity therein. The lid portion 1000 and the portion of the fishing lure or fishing device adjacent to the lid portion 1000 may detachably engage in any manner known in the art that would enable the two portions to remain engaged when, for example, exposed to water currents common to fishing. The force required to disengage the lid portion 1000 from the fishing lure or fishing device (e.g., alter the fish scent dispenser from the closed configuration to the open configuration) may be, however, consistent with operating the fish scent dispenser with, for example, a finger nail versus requiring a tool. In an embodiment, the lid portion 1000 and the portion of the fishing lure or fishing device adjacent to the lid portion 1000 are detachably engaged with a snap closure. The snap closure may be an annular snap, a cantilever snap, or any other type of snap closure.

The hinge 1020 is illustrative of an element by which the lid portion 1000 and the fishing lure or fishing device remain attached while the fish scent dispenser 100 is the open configuration. It is to be understood that any mechanism by which the lid portion 1000 and the fishing lure or fishing device would be attached could be used. Further, the hinge 1020 may be omitted and the fish scent dispenser 100 would comprise the lid portion 1000 as a separate component until detachably engaged to the fishing lure or fishing device to form the fish scent dispenser 100 with the cavity defined thereby.

The vents 1010 facilitate water flowing across the scent source to disperse scent from the fishing lure or fishing device. In general, a fishing lure or device is unidirectional. In other words, a fishing lure or device is connected, generally at one end, to the fishing line that is in turn, coupled to the fishing rod, fishing reel, and fisherman holding the rod and reel such that the fishing lure has a natural orientation as it is retrieved or trolled through the water. In an embodiment, the vents 1010 include entrance openings and exit openings parallel to an axis of the fish scent dispenser 100. The fish scent dispenser 100, when included in a fishing lure or device, may have the axis of the vents substantially parallel to the lure's or device's natural orientation based on its direction of retrieve or troll. By this configuration, water more easily flows through the vents 1010 of the fish scent dispenser 100, both reducing drag of the lure or device including the fish scent dispenser 100, and exposing more water to the scent source secured in the fish scent dispenser 100 cavity.

It is to be understood, however, that the vents may be configured differently. For example, the vents 1010 may be a single opening in lieu of entrance and exit openings. The vents 1010 may also be alterable such that the amount of water flowing through the vents can be controlled. For example, individual vent openings may be partially or completely occluded to reduce the amount of water flowing through the vent opening or openings. The alterable vents would allow a fisherman to control the quantity of scent provided as well as tune the lifespan of the scent source.

The vents 1010 may further be designed with hydrodynamically functional configurations. For example, the vents 1010 may be designed to steer, swirl, disrupt, or otherwise control the flow of influent water to alter the efficiency with which the fish scent dispenser 100 delivers scent to the effluent water. The vents 1010 may further be designed for a particular range of troll or retrieve speeds or lure and device type. For example, trolling for salmon occurs at a different speed than bottom fishing for sturgeon, catfish, or halibut. Each situation may require a different vent 1010 configuration to effectively deliver an appropriate amount of scent.

The fish scent dispenser 100 may be manufactured in a variety of materials with a variety of processes. In an embodiment, the fish scent dispenser 100 is fabricated of a plastic material that is injection molded. For example, the fish scent dispenser 100 may be fabricated from injection molded polypropylene. Polypropylene has an approximately neutral buoyancy so as not to adversely affect the device or lure in which it is included. Further, polypropylene is well suited for hinge 1020, particularly when hinge 1020 is configured as a living hinge. In another embodiment, the fish scent dispenser 100 is fabricated as part of the fishing lure or fishing device. Depending on the material of the fishing lure or fishing device, the lid portion 1000 maybe injection molded or otherwise formed from the same process that, for example, molds the fishing lure or fishing device. For example, the dodger 300 or the flasher 520 (as well as other fishing lures and devices) may be a molded plastic in which the lid portion 1000 may be integrally molded.

The lid portion 1000 material may further incorporate fish attracting color or color combinations, reflective material (e.g., glitter or metal flakes), glow-in-the-dark material, fluorescent material, and combinations thereof to match or offset the color of the fishing lure or fishing device in which the fish scent dispenser 100 is included. The color and/or other attracting material may be applied to the surface of the lid portion 1000 or it may be incorporated as an additive to the, for example, injection molded polypropylene or other plastic from which the lid portion 1000 is fabricated.

If not integrally molded as part of the fishing lure or fishing device, the lid portion 1000 may be attached to a fishing lure or fishing device with an ultrasonic weld, a heat weld, adhesive, epoxy, screw, bolt, nail, or a combination thereof. In particular, a lid portion 1000 fabricated with polypropylene as discussed above may be heat welded to a fishing lure or fishing device that has a similar plastic composition.

Though FIG. 10 illustrates the lid portion 1000 of the fish scent dispenser 100 as protruding from the surface of the fishing lure or device in which the fish scent dispenser is included, it is to be understood that the cavity may be formed in, for example, the surface of the fishing lure or fishing device and the lid portion 1000 maybe substantially flush with the surface of the fishing lure or fishing device when the fish scent dispenser 100 is in a closed configuration. In particular, given the location of the fish scent dispenser in the fishing lure or fishing device, and the action (e.g., spinning, wobbling, and vibrating) thereof, it may or may not be necessary to have a protruding lid portion 1000 to, for example, increase the water that may flow through the vents 1010.

The size of the fish scent dispenser 100 may also be altered depending on the size or intended use of the fishing lure or fishing device in which the fish scent dispenser 100 is included. For example, in a higher speed troll with a large flasher 520 or dodger 300, a larger fish scent dispenser 100 may be used to provide more cavity space for a scent source or scent sources. Given the size of the flasher 520 or dodger 300, the fishing device performance (e.g., spinning, oscillating, or similar motion) may not be sufficiently altered by including a single or multiple fish scent dispensers 100. Alternatively, a smaller fish scent dispenser 100 may be more appropriate to include in a fishing lure 150. For example, a smaller fish scent dispenser 100 is less likely to alter the performance of a, for example, crankbait for which the shape of the lure is highly important to determine its fish-attracting action as it is trolled or retrieved.

As noted, the cavity is accessible when the fish scent dispenser 100 is in the open configuration to apply, insert, or otherwise provide a scent source that is then contained within the fish scent dispenser 100 in a closed configuration. In an embodiment the scent source is a sponge material. The sponge material can be any type of material designed to absorb fish scent. In an alternate embodiment, the scent source is a hydrophilic foam. The fish scent, in the form of a liquid, gel, powder, or similar composition can be placed, squirted, squeezed, or otherwise provided to the sponge or hydrophilic foam material to disperse scent when the fish scent dispenser is submerged. In an embodiment, there are multiple sponges or pieces of hydrophilic foam.

The scent source may further be a paste or solid pellet of fish attracting material that is placed, squirted, squeezed or deposited within the cavity of the fish scent dispenser 100. There are many types of these paste, moldable, or solid material concoctions currently on the market that may be placed in the cavity in such a manner. For example, the scent source may be BERKELY TROUT DIP, BERKELY SELECT GLITTER TROUT BAIT, BERKELY GLITTER TURBO DOUGH, CRAVE NITRO DOUGH, CRAVE NITRO PREMIUM, CRAVE NITRO GREASE, CRAVE GRAVY, TOP SECRET AMINOGEL, EXUDE ERUPT, or EXUDE MAGIC MORSELS.

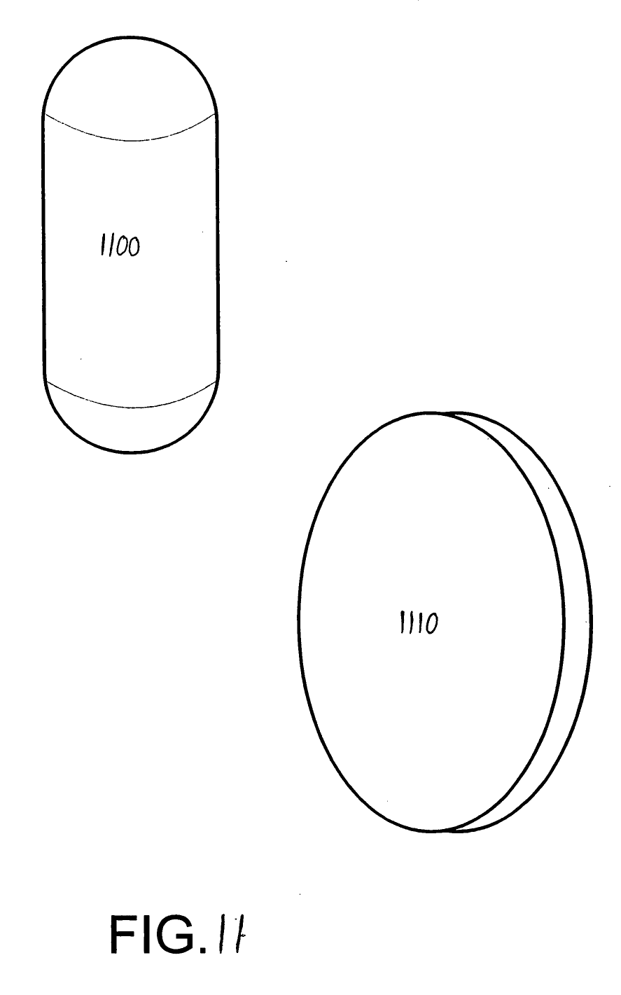

In addition to solid materials that may be used in place of a sponge, a scent-releasing tablet may be used in the cavity, such as illustrated by a pill-shaped oblong tablet 1100 and a round tablet 1110 in FIG. 11. In an embodiment, tablets 1100 and 1110 are made of a water-soluble material. The water-soluble tablets 1100 and 1110 dissolve gradually to release scent particles behind the fishing lure or fishing device including the fish scent dispenser 100 as the fishing lure or fishing device moves through the water. The dissolution of the tablet can vary based on the properties of the tablet, for example, to provide for a slower release. This can be accomplished by, for example, varying the size of the tablet or by altering the composition of the base material of the tablet. The dissolution rate can further be altered by the pressure under which tablet is formed. It is also contemplated that additional tablets may be used to increase the dissolution time or to incorporate a fisherman's recipe of multiple scents

In further regards to FIG. 11, the tablets 1100 and 1110 may release various scents to attract fish. Specific scents may be more specially adapted for use with certain species of fish, for example. An illustrative, but non-exclusive list of possible scents includes: shrimp scent, sturgeon scent, sardine scent, salmon egg milk, anchovy, crawfish, anise, sand shrimp, corn scent, garlic, salmon with roe, earthworm scent, smelt scent, shad, herring, catfish cocktail, minnow scent, kokanee scent, kenai scent, halibut chum, and hatchery scent. As noted, placing multiple tablets of different scents in the same dispenser may combine scents.

In addition to various scents, the tablets 1100 and 1110 may include various features of appearance that aid in attracting fish. For example, the tablets may be made of a material that is designed to be florescent, glow-in-the-dark, neon, or ultra-violet active. The tablet may further effervesce to create bubbles. Other colors, features, or combinations thereof may also be used.

In addition to the previously indicated variations, numerous other modifications and alternative arrangements may be devised by those skilled in the art without departing from the spirit and scope of the present invention and the appended claims are intended to cover such modifications and arrangements. Thus, while the present invention has been described above with particularity and detail in connection with an embodiment or embodiments of the invention, it will be apparent to those of ordinary skill in the art that numerous modifications, including, but not limited to, variations in size, materials, shape, form, function, manner of operation, assembly, and use may be made without departing from the principles and concepts set forth herein.

One skilled in the art will recognize the elegance of the disclosed embodiment in that it improves the ability with which fishermen can attract fish to their fishing lures.

1. An apparatus comprising:
a fishing lure;
a lid portion coupled to the fishing lure wherein the lid portion includes a plurality of vents, each vent including an entrance opening not flush with a surface of the fishing lure and an exit opening not flush with the surface of the fishing lure;
wherein the fishing lure and the lid portion define a cavity to secure a scent source when configured in a closed position.

2. The apparatus of claim 1 wherein the cavity is accessible to a user when the fishing lure and the lid portion are configured in an open position.

3. (canceled)

4. (canceled)

5. The apparatus of claim 1 wherein the lid portion is coupled to the fishing lure with a living hinge.

6. The apparatus of claim 1, the scent source located in the cavity to dispense scent through the vents when the fishing lure is submerged.

7. The apparatus of claim 6 wherein the scent source is located in the cavity when the fishing lure and lid portion are in the open position.

8. The apparatus of claim 6 wherein the scent source is secured in the cavity when the fishing lure and lid portion are in the closed position.

9. The apparatus of claim 1 wherein the scent source comprises a scent tablet.

10. The apparatus of claim 1 wherein the scent source comprises a sponge.

11. The apparatus of claim 1 wherein the scent source comprises a hydrophilic foam.

12. The apparatus of claim 1 wherein the fishing lure is selected from the group consisting of a crankbait, an in-line spinner, a spinner bait, a topwater bait, a spoon, and a jig.

13. The fish scent dispenser of claim 1 wherein the lid portion comprises polypropylene.

14. An apparatus comprising:
a fishing device;
a lid portion coupled to the fishing device wherein the lid portion includes a plurality of vents, each vent including an entrance opening not flush with a surface of the fishing lure and an exit opening not flush with the surface of the fishing lure;
wherein the fishing device and the lid portion define a cavity to secure a scent source when configured in a closed position.

15. The apparatus of claim 14 wherein the cavity is accessible to a user when the fishing device and the lid portion are configured in an open position.

16. (canceled)

17. (canceled)

18. The apparatus of claim 14 wherein the lid portion is coupled to the fishing device with a living hinge.

19. The apparatus of claim 14, the scent source located in the cavity to dispense scent through the vents when the fishing device is submerged.

20. The apparatus of claim 19 wherein the scent source is located in the cavity when the fishing device and lid portion are in the open position.

21. The apparatus of claim 19 wherein the scent source is secured in the cavity when the fishing device and lid portion are in the closed position.

22. The apparatus of claim 14 wherein the scent source comprises a scent tablet.

23. The apparatus of claim 14 wherein the scent source comprises a sponge.

24. The apparatus of claim 14 wherein the scent source comprises a hydrophilic foam.

25. The apparatus of claim 14 wherein the fishing device is selected from the group consisting of a diver, a dodger, a flasher, a spinner, a downrigger weight, a sinker, a floater, a spoon, a trolling rudder, a side planer, a bait holder, and a weight slide.

26. The apparatus of claim 14 wherein the lid portion comprises polypropylene.
